(19) United States
(12) Patent Application Publication
(10) Pub. No.: US 2014/0278205 A1
(43) Pub. Date: Sep. 18, 2014

(54) EMBEDDED PROCESSOR ON AN INTEGRATED MEMS SENSOR CHIP AUTONOMOUSLY MANAGING EXTERNAL SENSOR

(71) Applicant: INVENSENSE, INC., Sunnyvale, CA (US)

(72) Inventors: Vinod BHAT, San Jose, CA (US); Behrad ARIA, Alameda, CA (US)

(73) Assignee: INVENSENSE, INC., Sunnyvale, CA (US)

(21) Appl. No.: 13/797,345

(22) Filed: Mar. 12, 2013

(51) Int. Cl. G06F 3/00; G01P 15/00

(52) U.S. Cl. CPC G06F 3/002; G01P 15/00
USPC 702/141; 702/189

(57) ABSTRACT

A device and method for managing external sensors are disclosed. The device comprises at least one embedded processor and a memory device and at least one bus controller that can be used by the embedded processors to communicate with external sensors. The embedded processor includes a mechanism to receive a control input to retrieve raw data from at least one sensor external to the device. The embedded processors may include another mechanism to receive a control input interrupting the embedded processors at regular intervals of time to retrieve raw data from at least one sensor external to the device.

### CROSS-REFERENCE TO RELATED APPLICATION

This application is related to U.S. application Ser. No. 13/673,882, filed on Nov. 9, 2012, entitled “SELECTABLE COMMUNICATION INTERFACE CONFIGURATIONS FOR MOTION SENSING DEVICE”, and is also related to U.S. Pat. No. 8,310,380, issued on Nov. 13, 2012, entitled “SELECTABLE COMMUNICATION INTERFACE CONFIGURATIONS FOR MOTION SENSING DEVICE,” which both of are incorporated here by reference in its entirety.

### FIELD OF THE INVENTION

The present invention relates to sensor devices, and more particularly, to autonomously managing external sensors by an embedded processor located on an integrated sensor chip.

### BACKGROUND

Conventionally, sensor devices communicate with application processors that read data from external sensors only at the polling rate of internal sensors of the sensor devices which requires more processing power and takes longer time. There is a strong need for a cost-effective solution that overcomes the above mentioned issues. The present invention addresses such a need.

### SUMMARY OF THE INVENTION

A device and method for managing external sensors are disclosed. In a first aspect, the device comprises a motion processing unit (MPU) that includes a memory device and one or more sensors. The device includes an embedded processor coupled to the MPU, wherein the embedded processor includes a mechanism to receive a control input to retrieve raw data from at least one external sensor.

In a second aspect, the method comprises providing a sensor device with a motion processing unit (MPU) that includes a memory device and coupling an embedded processor to the MPU. The method includes receiving a control input by the embedded processor via a mechanism to retrieve raw data from at least one external sensor.

### BRIEF DESCRIPTION OF THE DRAWINGS

The accompanying figures illustrate several embodiments of the invention and, together with the description, serve to explain the principles of the invention. One of ordinary skill in the art readily recognizes that the embodiments illustrated in the figures are merely exemplary, and are not intended to limit the scope of the present invention.

FIG. 1 illustrates a top view block diagram of a device in accordance with an embodiment.

FIG. 2 illustrates a more detailed block diagram of a device in accordance with a first embodiment.

FIG. 3 illustrates a flowchart in accordance with an embodiment.

FIG. 4 illustrates a more detailed block diagram of a device in accordance with a second embodiment.

FIG. 5 illustrates a method for managing external sensors in accordance with an embodiment.

### DETAILED DESCRIPTION

The present invention relates to sensor devices, and more particularly, to autonomously managing external sensors by an embedded processor located on an integrated sensor chip. The following description is presented to enable one of ordinary skill in the art to make and use the invention and is provided in the context of a patent application and its requirements. Various modifications to the described embodiments and the generic principles and features described herein will be readily apparent to those skilled in the art. Thus, the present invention is not intended to be limited to the embodiments shown but is to be accorded the widest scope consistent with the principles and features described herein. In the described embodiments, device and sensor device are used to refer to a device with one or more sensors and other components. The sensors could be MEMS or solid state devices or any other type of sensors. Accelerometer, gyroscope, magnetometer, pressure sensors, and microphone are some of the examples of sensors. When the sensors reside on the device, they are referred to as internal sensors. External sensors reside outside the device.

A system and method in accordance with the present invention enables a sensor chip to autonomously manage external sensors via an embedded processor that is integrated on the sensor chip. The embedded processor retrieves raw sensor data from both internal sensors and the external sensors via a control input mechanism including but not limited to interrupt signal mechanism generated by the external sensors and trigger signal mechanism generated by a timer device also integrated on the sensor chip. As a result, the embedded processor processes the sensor data conventionally processed by an application processor that is in communication with the sensor chip.

To describe the features of the present invention in more detail, refer now to the following description in conjunction with the accompanying Figures.

FIG. 1 illustrates a top view block diagram of a device 100 in accordance with an embodiment. The device 100 is a motion processing unit (MPU) that comprises one or more internal sensors 102, an embedded processor 104, and a memory device 106. The device 100 is coupled both to one or more external sensors 108 and to an application processor 110. In this embodiment, the application processor 110 communicates with the device 100 and the embedded processor 104 communicates with the one or more external sensors 108.

In one embodiment, both the communication between the application processor 110 and the device 100 and the communication between the device 100 and the one or more external sensors 106 takes place over generic buses. One of ordinary skill in the art readily recognizes that the communication can take a variety of forms and that would be within the spirit and scope of the present invention.

In an embodiment, device 100 can include MEMS sensors and electronic circuit. In embodiment, the sensors can include MEMS accelerometers, gyroscope, magnetometer and pressure sensors. Some embodiments include accelerometer, gyroscope, and magnetometer each provide measurement along three axis orthogonal to each other. Other embodiments may not include all the sensors or may provide measurements along one or more axis. The sensors are formed on a first substrate.

In an embodiment, the electronic circuit receives the measurement outputs, store the raw data, and process the raw data to generate motion data apart from other operations. The electronic circuits may include DMA 208, memory 106, DMA 110, timer 212, embedded processor 104, and bus master 210. The electronic circuit is implemented on a second silicon substrate. The first substrate is vertically bonded to the second substrate.

In one embodiment, MPU 100 is implemented by vertically stacking and bonding the MEMS sensors on the first substrate to the electronic circuit on the second substrate using wafer-scale bonding processes as described in commonly owned U.S. Pat. No. 7,104,129 (incorporated by reference above) that simultaneously provides electrical connections and hermetically seals the MEMS devices. This unique and novel fabrication technique is the key enabling technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

FIG. 2 illustrates a more detailed block diagram of a device 200 in accordance with a first embodiment. The device 200 is a motion processing unit (MPU) that comprises one or more internal sensors 102, an embedded processor 104, a memory device 106, a direct memory access (DMA) device 208, a bus master device 210, and a timer 212. The device 200 is coupled to two external sensors 214-216 and to an application processor 218. One of ordinary skill in the art readily recognizes that a plurality of varying external sensors and devices can be coupled to and integrated on the device 200 and that would be within the spirit and scope of the present invention.

In one embodiment, the bus master device 210 is a bus controller that interfaces with the two external sensors 214-216 via a bus protocol that includes but is not limited to protocols 120 and SPI. In this embodiment, the bus master device 210 also communicates an Acknowledge (Ack) signal to the embedded processor 104 in response to receiving a Request (Req) signal (e.g. to retrieve raw data from the two external sensors 214-216) from the embedded processor 104.

In one embodiment, the memory device 106 stores sensor data that includes but is not limited to raw data and motion data and the embedded processor 104 processes the sensor data. In this embodiment, the memory device 106 stores both internal sensor raw data received from the one or more internal sensors 102 and external sensor raw data received from the two external sensors 214-216 via the bus master device 210. One of ordinary skill in the art readily recognizes that the memory device 106 can be a variety of memory types including but not limited to a First-In-First-Out (FIFO) type of memory and a static random-access memory (SRAM) type of memory and that would be within the spirit and scope of the present invention.

In one embodiment, the embedded processor 104 schedules reads from the two external sensors 214-216. The embedded processor 104 reads the stored raw data from the two external sensors 214-216 and the raw data from the internal sensors 102. The embedded processor 104 also performs sensor fusion via a variety of sensor fusion algorithms on the external sensor data that is combined with internal sensor data received from the one or more internal sensors 102 to produce motion data that is also stored on the memory device 106. The embedded processor 104 decides to either share the motion data with the application processor 218 for the application processor 218 to take further processing action or to not share the motion data with the application processor 218.

The embedded processor 104 enables the device 200 to achieve lower power consumption and faster processing in comparison to sensor data processing that is carried out by the application processor 218 because the embedded processor 104 is not a general purpose processor like the application processor 218, and thus can be realized with smaller hardware.

In one embodiment, the timer 212 is a programmable interval timer device that is used to schedule periodic reads (e.g. N number of seconds or milliseconds) from any of the one or more internal sensors 102 and the two external sensors 214-216. In this embodiment, the timer 212 counts up to a pre-programmed/predetermined value, generates a read by the embedded processor 104 via a trigger signal that is transmitted to the embedded processor 104, and then resets the count to start the next cycle. The trigger signal serves as a first type of control input mechanism to enable the embedded processor 104 to retrieve raw data from the two external sensors 214-216.

In one embodiment, the two external sensors 214-216 each communicate an interrupt signal to the embedded processor 104. Each interrupt signal serves as a second type of control input mechanism to enable the embedded processor 104 to retrieve raw data from the two external sensors 214-216. Both the trigger signal based first control input mechanism and the interrupt signal based second control input mechanism wake the device 200 from a low power state to retrieve data from the two external sensors 214-216.

In one embodiment, the embedded processor 104 retrieves raw data from the two external sensors 214-216 and from the one or more internal sensors 102. The retrieved raw data is processed by the embedded processor 104 to generate motion data which is subsequently transmitted to and stored in the memory device 106. In this embodiment, the device 200 returns back to a low power state after the raw data is processed by the embedded processor 104.

In one embodiment, the motion data stored in the memory device 106 is evaluated by the embedded processor 104 to generate an interrupt signal to interrupt the application processor 218 so that the application processor 218 can receive the motion data (and other data) from the memory device 106. In this embodiment, the interrupt signal is transmitted to the application processor 218 via the DMA device 208.

FIG. 3 illustrates a flowchart 300 in accordance with an embodiment. Referring to FIGS. 2 and 3 together, the flowchart 300 depicts a process of the embedded processor 104 for autonomously managing and reading data from the two external sensors 214-216. At step 302, the device 200 is idle and in a low power state with power to hardware components required to receive interrupt and trigger signals. The device 200 wakes up from the low power state and into a higher power state with power to additional hardware components when either the timer 212 expires or the embedded processor 104 receives an interrupt signal from the two external sensors 214-216, via step 304.

The embedded processor 104 schedules a read from the two external sensors 214-216 by programming the bus master device 210, via step 306 and waits for an ACK response from the bus master device 210 that is in communication with the two external sensors 214-216, via step 308. Once the embedded processor 104 receives an ACK response from the bus master device 210, the embedded processor 104 reads both internal and external sensor data that is stored in the memory device 106, via step 310. After reading the sensor data, the embedded processor 104 processes the sensor data for sensor fusion, via step 312.

The embedded processor 104 has the option of interrupting the application processor 218 to notify the application processor 218 of the processing that the embedded processor 104 conducted and any additional processing that may be required of the application processor 218, via step 314. In one embodiment, the determination by the embedded processor 104 to optionally notify the application processor 218 is facilitated by reaching a predetermined threshold of data. After processing sensor data, the embedded processor 104 then transitions the device 200 back to a low power state, via step 316, and the flowchart 300 returns back to step 302 with an idle device 200 to conserve power consumption.

The device can include a plurality of embedded processors that can interface and retrieve data from a plurality of external sensors. FIG. 4 illustrates a more detailed block diagram of a device 400 in accordance with a second embodiment. The device 400 is a motion processing unit (MPU) that comprises two internal sensors 402a-402b (Sensors 1 and 2), two embedded processors 404a-404b (Processors 1 and 2), a memory device 406, a bridge device 408, a bus arbitrator device 420, two bus master devices 410a-410b (Bus Masters 1 and 2), and two timers 412a-412b (Timers 1 and 2). The device 400 is coupled to a plurality of external sensors 450 (Sensors 3, 4, 5, 6).

In one embodiment, the bus arbitrator device 420 manages the two internal sensors 402a-402b and the bus master devices 410a-410b and facilitates storage of both internal and external raw data within the memory device 406 via the bridge device 408. In this embodiment, the two timers 412a-412b communicate trigger signals to the two embedded processors 404a-404b to retrieve raw data from both the two internal sensors 402a-402b and the plurality of external sensors 450 for sensor fusion processing.

In the two processor system memory is shared between two processors through the memory bridge 408. One of the processors for example processor 1 can be a general purpose embedded micro controller which upon system power up can initialize and configure the system, provide housekeeping functions such as memory, fifo, power and peripheral device management. It can also perform other control or algorithmic functions on the sensor data.

The second processor for example processor 2 can be a special purpose processor designed to perform certain tasks efficiently with minimum over head. These tasks could be digital signal processing functions such as Finite Impulse Response (FIR) filter using multiply, accumulate with circular buffer and zero overhead looping or a specific event recognition function for gesture recognitions.

Therefore in a two processor system such as one shown in FIG. 4, 404a processor 1 can call on 404b processor 2 to perform a specific task while 404a processor 1 simultaneously executes another instruction. When processor 2 is done with the assigned task it can notify the processor 1 and the results delivered to processor 1 can be stored in memory and become available to application processor.

The bridge 408 and bus arbiter 420 allow the two processors share the system resources in such a manner that their operations are not corrupted and they can meet the throughput required to perform their functions.

Such a configuration allows for one of more timers 412a and 412b to trigger a read of one or more external sensors 450 and transmit this trigger to either of the processors 404a or 404b to subsequently schedule the read on the bus master 410a or 410b that is connected to the external sensor that has to be read.

Such a configuration also allows for each of the external sensors 450 to generate an interrupt signal to either of the processor 404a or 404b. The processor subsequently schedules a read of the sensor in the bus master connected to the external sensor that has to be read.

FIG. 5 illustrates a method 500 for managing external sensors in accordance with an embodiment. The method 500 comprises providing a sensor device with a motion processing unit (MPU) that includes a memory device, via step 502, and coupling an embedded processor to the MPU, via step 504. The method 500 includes receiving a control input by the embedded processor via a mechanism to retrieve raw data from at least one external sensor, via step 506.

As above described, the system and method allow for a device to autonomously manage external sensors. By integrating an embedded processor on the sensor chip that schedules reads of sensor data and processes sensor fusion data without waking up an application processor that is coupled to the device, a lower system power consumption is achieved as the embedded processor consumes significantly lower power than the application processor. Additionally, faster processing is achieved as the embedded processor processes sensor fusion in real time without having to wait for the application processor to service an interrupt signal, read sensor data, and then process the sensor data in a software environment.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A device, comprising:
a memory; and
one or more embedded processors, wherein the one or more embedded processors includes a mechanism to receive a control input to retrieve raw data from at least one external sensor.

2. The device of claim 1, further comprising:
one or more bus controller, wherein the one or more bus controllers transfers the raw data from the at least one external sensor to the one or more embedded processors.

3. The device of claim 2, further comprising storing the raw data in the memory before transferring to the one or more embedded processors.

4. The device of claim 1, wherein the mechanism is an interrupt signal from the at least one external sensor.

5. The device of claim 1, wherein the mechanism is a trigger signal from one or more timer devices of the MPU.

6. The device of claim 5, wherein the one or more timer devices is a programmable interval timer.

7. The device of claim 1, wherein the control input wakes the device from a low power state to retrieve data from the at least one external sensor.

8. The device of claim 1, wherein the memory device is any of a First-In-First-Out (FIFO) type and a static random-access memory (SRAM) type.

9. The device of claim 1, wherein the memory device stores data that comprises any of raw data and motion data.

10. The device of claim 1, wherein the raw data includes a first raw data from the at least one external sensor and a second raw data from at least one internal sensor on the device, further wherein the first raw data and the second raw data is processed to generate motion data that is stored in the memory device.

11. The device of claim 10, wherein the motion data is evaluated by the embedded processor to generate an interrupt signal to interrupt an application processor coupled to the device.

12. The device of claim 11, wherein the application processor retrieves data from the memory device when interrupted.

13. The device of claim 10, wherein the device returns to a low power state after the raw data is processed by the one or more embedded processors.

14. A method for managing external sensors, the method comprising:
providing a device with a motion processing unit (MPU) that includes a memory device;
coupling one or more embedded processors to the MPU; and
receiving a control input by the one or more embedded processors via a mechanism to retrieve raw data from at least one external sensor.

15. The method of claim 14, further comprising:
transferring the raw data from the at least one external sensor to the one or more embedded processors by the one or more bus controllers.

16. The method of claim 14, wherein the mechanism is any of receiving an interrupt signal from the at least one external sensor and receiving a trigger signal from one or more timer devices of the MPU.

17. The method of claim 14, further comprising:
waking the device from a low power state via the control input to retrieve data from the at least one external sensor.

18. The method of claim 14, further comprising:
storing data that comprises any of raw data and motion data by the memory device.

19. The method of claim 14, wherein the raw data includes a first raw data from the at least one external sensor and a second raw data from at least one internal sensor of the MPU, further comprising:
processing the raw data to generate motion data; and
storing the motion data in the memory device.

20. The method of claim 19, further comprising:
evaluating the motion data by the one or more embedded processors to generate an interrupt signal to interrupt an application processor coupled to the MPU; and
retrieving data from the memory device by the application processor when interrupted.

21. The method of claim 19, further comprising:
returning to a low power state by the device after the processing of the raw data by the one or more embedded processors.
